(19) United States
(12) Patent Application Publication
(10) Pub. No.: US 2011/0085348 A1
(43) Pub. Date: Apr. 14, 2011

(54) LED light source for fiber optic cable

(76) Inventor: Paul J. Dobson, Charlton, MA (US)

(21) Appl. No.: 12/587,757

(22) Filed: Oct. 13, 2009

(51) Int. Cl. G02B 6/00

(52) U.S. Cl. 362/551

(57) ABSTRACT

A high efficiency fiber optic illuminator comprises a light emitting device with wide angular light distribution, such as an LED, and an outwardly tapered fiber optic waveguide rod with a large calculated numerical aperture, preferably equal to or greater than 0.7 and a ratio of the output diameter to the input diameter of between 1.4:1 and 2.2:1. The smaller, input end of the tapered rod is supported close to the light emitting surface so as to collect the maximum amount of energy. The input end is capable of accepting light at very high angles of incidence, and reducing those angles of incidence so that when the light exits the larger, output end the light may be accepted by standard fiber optic devices with typical numerical aperture values ranging between 0.4 and 0.7.

### BACKGROUND

The present invention relates to light sources, and particularly to illuminator sources for optic cables, especially illuminators having a light emitting (LED) source.

Fiber optic devices, both flexible and rigid, have been used for several decades to provide illumination in locations that are physically remote from the light source. Fiber optic devices are passive, simply carrying energy in the form of light from one end to the other and are thus well suited for illuminating sensitive areas such as explosive environments or medical procedures during which there must be no risk of electric shock or sparks as can arise with electric light sources.

Fiber optic devices which are used for illumination have been driven traditionally, by light sources that are based upon variations of incandescent light bulbs or short arc lamps. Both of these types of light sources suffer from short life and excessive generation of heat with associated infra red (IR) light energy. As a consequence the fiber optic components must be built with expensive techniques to tolerate the heat or filter out the IR energy.

One improvement in use for several years incorporates a light emitting diode (LED) to provide illumination to the end of a fiber optic device. U.S. Pat. No. 6,826,336 dated Nov. 30, 2004 discloses an elaborate method of coupling energy from a light emitting diode into a rigid fiber optic rod (i.e., waveguide coupling). In this patent domes, reflectors, and bonding agents are all used in an attempt to couple the greatest amount of energy from the light emitting diode into the fiber optic component. U.S. Pat. No. 7,041,054 dated May 9, 2006, discloses the most basic technique to couple energy from a light emitting diode into a fiber optic device, by simply placing the two objects as close together as possible. U.S. Pat. No. 6,290,382 dated Sep. 18, 2001 discloses another complex technique to gather as much energy as possible from a plurality of light emitting diodes and couple that energy into a fiber optic device.

Each of the foregoing examples suffers from either low coupling efficiency, inordinate complexity, or both. The methods disclosed U.S. Pat. No. 6,290,382 are exceedingly complex, and the actual coupling efficiency is not evident. The technique described in U.S. Pat. No. 7,041,054 has the advantage of simplicity but due to the inherent high angular distribution of light energy from a light emitting diode, this advantage is offset by low efficiency.

U.S. Pat. No. 6,826,336 depicts a method of transferring energy from a light emitting diode into a fiber optic waveguide rod that allows the fiber optic rod to accept a very high degree of energy from the light emitting diode, but a significant fraction of the accepted light flux is lost before reaching the output end of the waveguide. The fiber optic rod is in contact with the light emitting surface of the LED source. Much of the energy from the LED is emitted at very high angles when compared to the axis of the fiber optic rod. The angle θ indicated at numeric ID 108 in FIG. 1 of that patent, which indicates the angle a light ray makes with the axis of the rod, appears to be well outside the maximum acceptance angle of about 40 degrees off axis for most common fiber optic components. This maximum acceptance angle corresponds to a numerical aperture (N.A.) of 0.66.

According to the '336 patent the inventor selected a fiber optic rod with a very high N.A. to match the pattern of the light from the light emitting diode, and thus is able to collect a large amount of the energy from the light emitting diode. This is not difficult as there are readily available glass combinations which yield an N.A. of 1.0, and so are capable of collecting virtually all of the energy from the light emitting diode. There are several problems with this approach to collecting energy from the light emitting diode and then putting it to practical use. First, the glass combinations which yield N.A. values approaching 1.0 use very dense glass for the core which typically has low transmission in lengths greater than a few inches. Second, as can be seen in the aforementioned FIG. 1, the rays of light in a waveguide rod are propagated through the rod by reflection off the cladding at the same angle that they entered the fiber.

### SUMMARY

The primary object of the present invention is to provide an illuminator, especially an LED illuminator, having a more efficient coupling of energy through a waveguide between the preferably LED source and an end-use fiber optic device.

Another object of the invention is to provide an illuminator having a waveguide that more closely matches the light distribution angles of common fiber cables.

Another object is to provide a technique for illuminating a larger diameter fiber optic device from a given size light source.

A further object is to provide an illuminator of given output, in a smaller package than available in reflector systems.

Yet another object is to provide an illuminator that is less costly, more rugged, and easier to keep clean than comparable reflector systems.

The illuminator disclosed herein overcomes the drawbacks of the previous systems while providing a brilliant white light that is easy to couple into the end of a fiber optic device. It provides more efficient coupling of energy from an LED into a fiber optic device, reduces the light distribution angles to match common fiber types, and is capable of illuminating a larger diameter fiber optic from a given size light source. It is smaller, less expensive, more rugged and easier to keep clean than comparable reflector systems.

The basic elements of the invention are a light emitting device with wide angular light distribution, such as an LED, and an associated coupling waveguide in the form of a tapered fiber optic rod having a large calculated N.A.

Optionally but preferably, anti-reflective coatings are provided on the LED and the tapered rod.

The inventive combination can be implemented with other forms of light generating devices such as plasma or arc lamps.

### BRIEF DESCRIPTION OF THE DRAWING

These and other features and advantages will be evident to practitioners in the field, from the following detailed description and the accompanying drawing, in which:

FIG. 1 is a representative side view of an LED illuminator that embodies aspects of the present invention;

FIG. 2 is a longitudinal section view of an alternative waveguide rod for the illuminator of FIG. 1;

FIG. 3 is a detailed view of the preferred mounting of the waveguide in closely spaced relation to the glass cover of an LED emitter surface;

FIG. 4 is a view similar to FIG. 1, of a conventional cylindrical waveguide; and

FIGS. 5-7 are isometric, side, and longitudinal section views, respectively, of a third embodiment of the invention.

### DETAILED DESCRIPTION

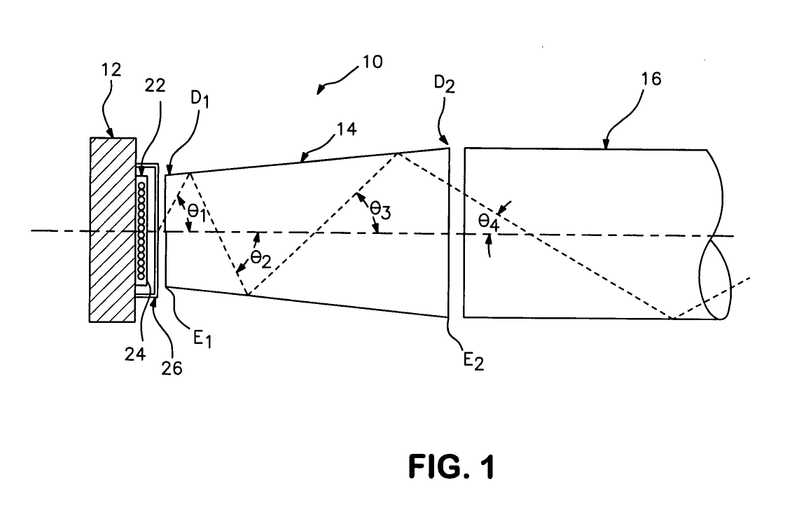

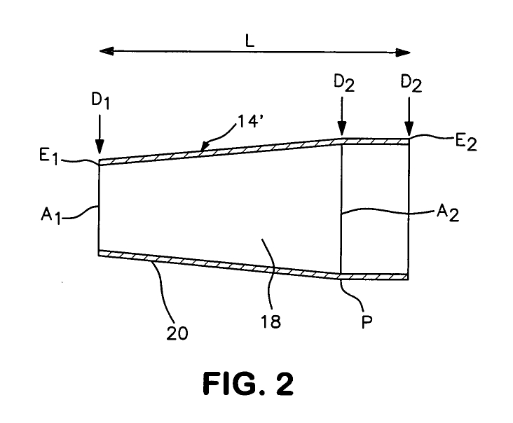

FIGS. 1 and 2 show two embodiments of a high efficiency fiber optic illuminator 10 comprising a light emitting source 12 and an elongated fiber optic waveguide 14, 14′ having an input end E1 confronting the source 12 and an output end E2 to be mated with a fiber optic cable 16 or similar optic device. The overall arrangement is conventional, as represented by U.S. Pat. No. 6,826,336, the entire disclosure of which is hereby incorporated by reference. The significant difference according to the present invention is that the waveguide 14 does not maintain a uniform cross section, but rather tapers outwardly between the input end E1 and the output end E2.

The waveguides 14, 14′ preferably has a circular cross section over its entire length L, extending between the inlet end E1 and the output end E2. The taper begins from a minimum diameter D1 at the input end E1 defining a minimum area A1 and increases to a maximum diameter D2 at a position P along the length and defining a maximum area A2. In the embodiment of FIG. 1, position P is at the output end E2, whereas in the embodiment of FIG. 2, a short cylindrical portion of uniform diameter D2 extends between position P and the output end E2.

The waveguide 14 comprises an optically conductive solid core 18 having a core index of refraction N1 and an optically reflective cladding 20 having a cladding index of refraction N2 that is lower than the core index of refraction. The outward taper maximizes the fraction of the input source light that is reflected internally by the cladding, for propagation through the full length L of the guide 14 into the cable 16. The most common form of cladding is a layer or film of solid material integrally connected to and annularly surrounding the core. However, the present invention can be implemented even with cladding that is a gaseous material surrounding and in intimate contact with the core. For example, a tapered glass rod can be supported in a sealed chamber, using air as a cladding.

The improvement realized with the outward taper is indicated by the dashed line extending through the waveguide of FIG. 1. An incident ray entering the input end at a high angle θ1 relative to the waveguide axis is reflected at a smaller angle θ2 relative to the axis due to the increasing angle of the waveguide reflecting surface (cladding) relative to the axis. As a practical matter, the angle of reflection θ1 of the initial ray decreases with each internal reflection θ2, θ3 within the taper of the waveguide, such that incidence angle θ4 at the entry to the optic device 16 is within the limit of internal reflectivity of the optic device. With cylindrical waveguides, the reflection angle for a given ray that enters the waveguide within the limit angle of the waveguide, is internally reflected at that angle and enters the optic device at that angle.

The invention can be implemented with the numerical aperture of the waveguide being equal to or greater than about 0.7, preferably greater than about 0.8, calculated as the square root of the difference between N1² and N2². The ratio D2/D1 should lie between about 1.4 and 2.2. Selection of the ratio D2/D1 is dependent on several factors.

The waveguide design starts with the matching of D2 with the input diameter of the optic device, e.g., a light guide for an optic device with input diameter of 0.4 inches and an N.A. of 0.56. The numerical aperture defines the maximum acceptance angle (critical angle) to admit and transmit light by a fiber. To calculate the critical angle, first determine the N.A. and then compute the corresponding the arcsine. For example, for an N.A. of 0.56, the arcsine and thus critical angle are 34 degrees. If the LED source is known to have a 65 degree effective angle of source light distribution that can be captured at D1 of the inventive waveguide coupling, the arcsine of that angle is 0.90. This implies a 0.90/0.56 taper ratio D2/D1 of about 1.6.

In the preferred implementation, the light source is a light emitting diode (LED) 22. The LED is typically a rectangular solid of semi-conductor material having a light emitting surface 24 and a glass cover 26. This cover defines the external surface of the light source and the light passing through this surface defines the theoretically usable photon flux. The area A1 of the input end of the waveguide confronts the area S of the emitting surface. The objective is for the waveguide to maximize the capture of the source flux at the inlet end E1 and the delivery into the optic cable 16 at outlet end E2. This is facilitated by fixturing the waveguide circular input and E1 perpendicularly and as close to the glass cover 26 as possible, taking into account that the greater the spacing the more of the source light flux is lost via leakage even before entry into the waveguide, while some spacing is preferred to account for the effects of differential expansion, handling, and other external forces.

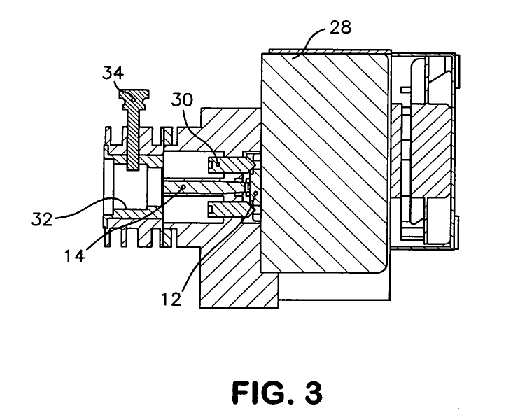

FIG. 3 shows the preferred fixture. The LED chip 12 is secured to the base 28 with two mounting screws 30 and the optic device is inserted into the receiving bore 32 at the front end and secured in place with a thumb screw 34. The waveguide 14 is fixedly supported in front of the LED in coaxial alignment with the bore for the optic device. The waveguide is fixtured for precise spacing from the LED glass cover. During manufacture, the waveguide is set with a shim the desired distance from the LED cover, such as 0.006 inch. This distance is determined by the properties of the materials selected to support the LED and the waveguide holder. The shim is kept in place while epoxy is applied to bond the waveguide to the waveguide holder, and then is removed. It is believed the present invention provides significant improvement relative to conventional waveguides if spaced within 0.030 inch of the glass cover 26, preferably within 0.005 to 0.010 inch.

With the waveguide fixed by epoxy in spaced relation to the LED, the fixture is adapted to receive the input end of an optical device with a spacing of less than about 0.025 inch, preferably about 0.010 inch, as secured by the thumb screw 34.

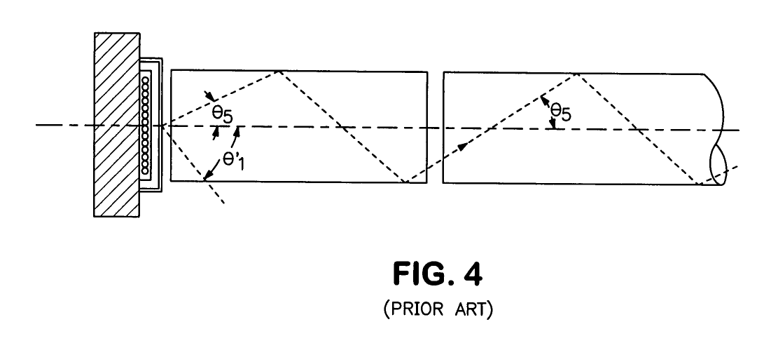

FIG. 4 shows that for a relatively shallow incident angle θ5, the conventional cylindrical waveguide can efficiently reflect internally and match up with the reflectivity of the optic device. However, for the same wide angle of incidence θ1′ as shown in FIG. 1 for the inventive device, there is no reflection and this light ray is lost, i.e., it never reaches the optic device. If the index of refraction of the cylindrical waveguide is increase sufficiently to accept a ray at a high incidence angle such as θ1, this angle is maintained internally and output to the optic device, but the angle θ1 is too high for the optic device and thus this ray is wasted. As explained previously, the outward taper of the waveguide of FIG. 1 internally reflects rays for all incidence angles up to a maximum of θ1 but delivers at lower angles such as theata 4 that are within the limits of the optic device, and thus provides greater efficiency than conventional cylindrical waveguides.

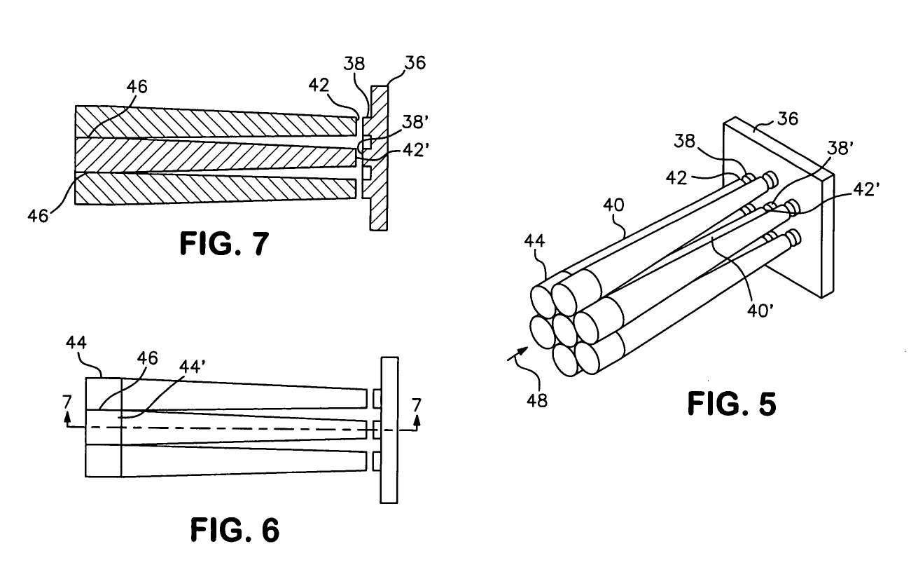

FIGS. 5-7 show another embodiment, in which the illuminator base 36 has a closely spaced pattern of six LED chips 38 surrounding a central LED chip 38′ and a respective closely spaced pattern of the input ends of six waveguides 40 surrounding a central waveguide 40′. Each waveguide 40, 40′ is of the type described with respect to FIG. 2. The input ends 42, 42′ are fixtured in spaced relation from the respective LED's 38, 38′ in the manner described with respect to FIG. 3. Preferably, the cylindrical end portions 44, 44′ of all the waveguides have longitudinal line contact 46 with at least one, most preferably at least two, adjacent waveguides, whereby the seven waveguides form a rigid bundle that performs as a unitary illuminator. When viewed coaxially into the output end as indicated at 48, the tight bundle of seven waveguides presents a nearly circular beam of light that can enter an optic device (e.g., light guide) having an input diameter approximately equal to the perimeter of the bundle.

In general end usage, the waveguide of the inventive illuminator is matched with the input end of a conventional optic device having a numerical aperture in the range of about 0.4 to 0.7. The waveguide preferably has a large numeric aperture, e.g., at least about 0.8, with the output of the waveguide providing an entry angle into the optic device that can be conducted by the device.

It should be appreciated that some optic devices have input ends that are other than circular, e.g., square or hexagonal. The waveguide according to the present invention can have a corresponding cross sectional shape that increases in area from the input end toward the output end. Such shape can be achieved by drawing a glass rod through a square die and tapering the resulting square rod.

1. A high efficiency fiber optic illuminator comprising a light emitting source and an elongated fiber optic waveguide having an input end confronting the source and an output end to be mated with a fiber optic device, wherein the waveguide tapers outwardly between the input end and the output end.

2. The illuminator of claim 1, wherein the waveguide has a circular cross section over its entire length.

3. The illuminator of claim 2, wherein the waveguide has a length L from the input end E1 to the output end E2, the taper begins from a minimum diameter D1 at the input end E1 and increases to a maximum diameter D2 at a position P along the length.

4. The illuminator of claim 3, wherein position P is at the output end E2.

5. The illuminator of claim 3, wherein position P is between the input end E1 and the output end E2, and the waveguide has a uniform diameter D2 between position P and the output end E2.

6. The illuminator of claim 1, wherein the waveguide comprises an optically conductive core having a core index of refraction N1 and an optically reflective cladding having a cladding index of refraction N2 that is lower than the core index of refraction.

7. The illuminator of claim 6, wherein the cladding is a layer of solid material integrally connected to and completely surrounding the core.

8. The illuminator of claim 6, wherein the cladding is a gaseous material surrounding and in intimate contact with the core.

9. The illuminator of claim 1, wherein the light emitting source is a light emitting diode (LED).

10. The illuminator of claim 9, wherein
the waveguide has a circular cross section over its entire length L, between the input end E1 and the output end E2;
the taper begins from a minimum diameter D1 defining an area A1 at the input end E1 and increases to a maximum diameter D2 toward the output end E2 such that D2 defines a maximum area A2;
the LED has a flat, light emitting surface having an area S; and
the area A1 of the input end of the waveguide confronts the area S of the light emitting surface.

11. The illuminator of claim 10, wherein the light emitting surface includes a glass cover and the input end E1 of the waveguide is supported perpendicularly to and in spaced relation within 0.030 inch from the glass cover.

12. The illuminator of claim 1, wherein
the waveguide comprises an optically conductive core having a core index of refraction N1 and an optically reflective cladding having a cladding index of refraction N2 that is less than the core index of refraction;
the waveguide has a circular cross section over its entire length L, from the input end E1 to the output end E2;
the taper begins from a minimum diameter D1 defining an area A1 at the input end E1 and increases to a maximum diameter D2 toward the outlet end E2 such that D2 defines a maximum area A2; and
the numerical aperture of the waveguide is at least about 0.7, calculated as the square root of the difference (N1²−N2²).

13. The illuminator of claim 12, wherein the ratio D2/D1 lies between about 1.4 and 2.2.

14. The illuminator of claim 3, wherein a plurality of substantially identical LED light sources are arrayed in a closely spaced pattern and a respective plurality of said waveguides are arrayed with their input ends in a corresponding closely spaced pattern confronting the light sources.

15. The illuminator of claim 5, wherein
a plurality of substantially identical LED light sources are arrayed in a closely spaced pattern and a respective plurality of said waveguides are arrayed with their input ends in a corresponding closely spaced pattern confronting the light sources; and
the uniform diameter portion of diameter D2 between position P and the output end E2 of each waveguide is in line contact with the uniform diameter portion of another waveguide.

16. The illuminator of claim 15, wherein
each waveguide comprises an optically conductive core having a core index of refraction N1 and an optically reflective cladding having a cladding index of refraction N2 that is less than the core index of refraction;
each waveguide has a circular cross section over its entire length L, from the input end E1 to the output end E2;
the taper begins from a minimum diameter D1 defining an area A1 at the input end E1 and increases to a maximum diameter D2 toward the outlet end E2 such that D2 defines a maximum area A2; and
the numerical aperture of the waveguide is at least about 0.7, calculated as the square root of the difference (N1²−N2²).

17. The illuminator of claim 16, wherein the ratio D2/D1 lies between about 1.4 and 2.2.

18. The illuminator of claim 17, wherein
the illuminator has a base with six LED chips surrounding a central LED chip and a respective six waveguides surrounding a central waveguide;
the input ends E1 of the waveguides are fixtured in spaced relation from the respective LED's; and
the uniform diameter end portions of all the waveguides have longitudinal line contact with at least two adjacent waveguides.

19. The illuminator of claim 12, wherein
the light source is an LED having a glass cover and the input end E1 of the waveguide is supported perpendicularly to and in spaced relation within the range of about 0.005 to 0.010 inch from the glass cover;
the numerical aperture of the waveguide is at least 0.8; and
the ratio D2/D1 lies between about 1.4 and 2.2.

20. The illuminator of claim 19, including an optic device at the output end E2 of the waveguide having a numerical aperture in the range of 0.4 to 0.7.

21. The illuminator of claim 1, wherein
the waveguide comprises an optically conductive core having a core index of refraction N1 and an optically reflective cladding having a cladding index of refraction N2 that is less than the core index of refraction;
the waveguide has a uniformly shaped cross section over its entire length L, from the input end E1 to the output end E2;
the taper begins from a minimum area A1 at the input end E1 and increases to a maximum area A2 at or adjacent to the output end E2; and
the numerical aperture of the waveguide is at least 0.8, calculated as the square root of the difference (N1²−N2²).
